(19) United States
(12) Patent Application Publication
(10) Pub. No.: US 2012/0150590 A1
(43) Pub. Date: Jun. 14, 2012

(54) Social network of political opinion and alternative virtual representation

(76) Inventor: Raanan Liebermann, North Haven, CT (US)

(21) Appl. No.: 13/373,582

(22) Filed: Nov. 21, 2011

Related U.S. Application Data
(60) Provisional application No. 61/459,342, filed on Dec. 13, 2010.

(51) Int. Cl. G07C 13/00; G06F 15/16

(52) U.S. Cl. 705/12; 709/217

(57) ABSTRACT

A service, system and method for electing individuals to virtual political capacity, encouraging and fostering local, national and international political debate via social networking tools and allowing to hold elected officials fully accountable, as well as allowing for alternative governing bodies to exist in virtual format and when appropriate in quasi-virtual format that is transparent to all. The virtual office holders may assist in resolving local, state, national and international issues. Dynamic interactive voting and polling provide instantaneous visual results for all in real-time.

### CROSS REFERENCE TO RELATED APPLICATION(S)

This application claims the benefit of U.S. provisional patent application No. 61/459,342 filed Dec. 13, 2010, entitled “SOCIAL NETWORK OF POLITICAL OPINION”, that is incorporated herein by reference in its entirety.

### BACKGROUND

1. Field of the Invention

The present invention relates to a jointly and severally a service, system and method of a process enabling individuals to partake in the political, as well as religious systems and processes, domestically and/or internationally, where their individual voice counts and can be countable, promoting accountability of elected officials to their constituents and make appropriate changes requested by voluminous numbers of constituents. It further lays the ground for a suitable democratic alternative, as well as creating a parallel body of virtual government officials that can on one hand mirror what is expected of the actual governing representatives, as well as negotiate and reach resolutions with their virtual counterparts, who each can then take such resolution to the actual governing representative for endorsement. The present disclosure is a doctrine utility that takes into account that an opposition party to any democratic governing system is not devout of personal interests and election related agendas. The remedy offered by the disclosure doctrine utility levels the plain field and ushers a true democratic equilibrium, where the only interest of its elected members for a virtual office is to truly represent the people and their needs. Money cannot sway an election based on the disclosed doctrine utility and is truly pluralistic. The aim as disclosed herein is to usher a new era without the need for revolution and by adhering to basic and pure democratic ideas and actions. The goal is to benefit future governing systems that are created, come about and held responsible and responsive to the individuals of the land, as based on the Constitution in the United States and similar counterpart documents in other countries.

Said service system and method may be enabled and facilitated by electronic media encompassing such facilities as limited character message in communication length transmitted, real-time or close to it distribution of messages exposed for all to see (feel or hear if disabled) and a polling system that may be inherent to presentations and/or any interactive communication via a focal point of receipt and distribution.

First we show why said doctrine utility is needed, what is solves, what is laid out and its utility to local national and global governing systems. Basically, the doctrine utility is aimed at elevating mankind to a democracy with equilibrium^{[1]} that is maintained between social needs and responsibility to practical utilization of a growing industrial world. [1] Hassia Bar Netzer-Leon, blogger; (personal communication)

Let us start with an example of laying-off employees and look at a corporation that needs to make a choice in order to preserve and grow profits for shareholders. The cold practical action calls to lay off several hundred employees, which will save money to the corporation quite immediately and improve its bottom line. The human approach is in dichotomy opposite in it approach to save/make the money. Namely, borrow money and undertake the interest expense so that the corporation could utilize its manpower to innovate, which will lead to future profits and growth, where all the employees that were going to be laid off would then be gainfully employed while the corporation thrives. The two approaches are different in that one has short-range benefits (laying off employees), while the other (innovate) has long-range benefits. Let us put aside the issue of which is the right decision—the cold corporate one or the human element one—and concentrate on the big picture of the corporation's role, not only in its immediate neighborhood of its stockholders, but also its role in the larger circle that encompass its national responsibility as a contributor to a sound fiscal and economic basis for the country. We note immediately that by choosing the long-range approach, the corporation would be contributing to the growth and thereby the strength of the Gross National Product (GDP) and become a vehicle for a stronger economy benefiting the nation, as well as its stockholders.

Corporations are important because they handle food, staples, transportation and infrastructure for the people, let alone providing employment to individuals from the public who use their earned income for purchasing goods that stimulates the economy. So the question remains, as to what is the solution and how to establish a just equilibrium in the democracy. The disclosed doctrine utility provides and builds a desired solution; a solution that mirrors a peaceful revolution on one side, mirrors a governing body that not only is open to the interests of the people, but is literally composed of such interests, in a responsible way achieved through democratic means; and finally, also enables a bridge for turning that mirror into actuality under certain conditions borne by and adhered to democratic principles.

If we look at the United States of America, we can see too major opposing sides in politics, but when we dig below the surface, each of the opposing sides has a point that needs to be considered. But such consideration needs to be outside of political games and maneuvers. It needs to be without personal interest that caters to electoral interests. This is the basis for our advanced theory with its practical solution borne by the material disclosed here that we call the doctrine utility for virtual governing effect.

Let us take a look at another example. One party claims that regulations are important as safeguards for the public. The other party contends that regulations are a hindrance to business prosperity and the costly bureaucracy that prevails with such regulations, which is in the way and needs to be abolished. Both sides have a point. The claim that regulations are in the way of business prosperity is correct to a degree. Safeguards for the public is by itself not inherent in the corporation philosophy, as corporations are after all designed to make money and are not human entities, albeit being governed by humans. The burden is then shifted to the humans governing the corporations who need to satisfy their allegiance to their job that demands the corporation makes money, yet handling the human issues as well based on their personal affinity. It is basically not fair to put such choice on the shoulders of the governing body of a corporation and the results are usually well known with the tilt towards the responsibility for the entity for which the governing board is the a fiduciary, namely profits and prosperity as short term benefits.

Further, considering now the issue of the bureaucracy and its costs, we realize that indeed bureaucrats can utilize the regulations not necessarily for the betterment of the citizen and not for but merely because for many bureaucrats (though not all), that is what they know to do, rather than develop, innovate and market profitably, overcoming difficulties and market conditions, which admittedly is not their agenda and not their mandate. Here again, they are the fiduciary for ascertaining policy, yet by the nature of those hired for the task, it becomes burdensome to handle, resulting in their refuge sought behind the paperwork and the unending adherence to it in enforcement of the regulations. We will see how the situation is solved when we introduce our doctrine.

2. Prior Art

The public has evolved to the stage where the Internet allows to become more vocal regarding issues of dissatisfaction and interest in change. Change.org is a web site allowing complaints form members of the public and counting all the support each complaint that carries momentum with it. The next step in the evolution is to select a member representative of the public to carry the torch proactively towards a resolution without waiting for the other side to notice the growing dissatisfaction. This is where the doctrine utility comes in.

The forefathers of the American democratic system envisioned the media to be the protecting voice of democracy and wisely accorded the freedom of the press. Thus, the media protects democracy by exposure but has no power beyond it that could practically enable or bring about change. Furthermore, the media is mostly made of corporations where profits its basic tenet, though the products sold to its customers are different customary staples. These types of media corporations depend on ratings that ensure enough customers that beget the important vehicle for income derived from selling advertising. Namely, such media products of information are symbiotically connected to the products sold by its patrons. It certainly does not help when the corporations working to sell products of other corporations are the watchdogs entrusted with guarding the democracy in the interests of the people that may clash with the interest of the advertising entities. Further, the media has also undergone evolution and has become politicized. We find newspapers siding with rightwing policies and likewise newspapers siding with liberal policies and interests and newspapers and television stations show polarization in their representations. It appears that a broker, unbiased by its own needs would be beneficial as an added guard to democracy, without undermining the industrial machinery needed for maintaining economic stability. Namely, what is needed is an equilibrium champion. This is where the doctrine utility comes in.

### SUMMARY OF THE INVENTION

In accordance with this instant disclosure, there is described a system for virtual and quasi-virtual public officials that mirrors legally governing positions. The virtual public official have no legal power to govern but have the public behind them in every step of the way to critique action, offer solutions and mobilize great amount of public support at an instant. The virtual and quasi-virtual office holders can communicate with other virtual and quasi-virtual office holders to resolve issues and then approach the legally governing officials for endorsement and execution. The doctrine forces elected officials to operate in efficient, timely manner that caters to the interests of the public, while ascertaining and maintaining responsibility to proper governing. We will see below the details of how it works. The virtual office holders are different from an opposition to a governing establishment, since they cannot be pulled into a coalition government, nor be promised support for their agenda in return for support for the current governing entity. Namely, no bargaining or deals are feasible under our doctrine, where some interests of the public could be compromised in a calculated move of governing.

Let us consider the issue of bureaucracy we tackled before. Under our doctrine of virtual positions, where each move and act is fully supported by the majority of the public, such bureaucracy is handled in a particular way under the auspices of the Quasi-Virtual Bureaucracy Fixing Office (QVBFO) that will be outlined below under the explanation of the drawings.

We can see the public partaking in pluralistic contribution for the benefits of others in the contributions made by individuals to “Wiki”. In our doctrine we climb up a step where the public literally presents a mirror to the governing individuals and system. Yet, it does more than that by getting involved without crossing any boundaries and operating only in the confines of the local, national and global virtual circles. However, it does provide the base from where the individuals elected to virtual positions can communicate within the circle of virtual governing facades and then take their achieved agreements that may cross territorial boundaries, but still in their boundary of virtual office circles and communicate such results to those in the circle of legally governing offices. The crossing out of boundaries is voluntary to both cohabitants of circles and the bridging over is done with full consent of the protagonists in both circles. We also witness how an individual that is now a citizen without the office of legally governing position brings about change by boldly advancing his wisdom to the legally governing body that accepts it for the benefit of the public. Point in case is the economist Paul Volker, the former chairman of the Federal Reserve, who drafted what is now called “The Volker's Rule” that has been accepted and already passed a committee on its way for legislation. Our doctrine expands such isolated cases into a systematic format for the public to follow.

Virtual positions encompass in our doctrine disclosure an arena wider than merely political office holders and is extended to actual governing elements, while not being part of an elected actual governing body. For example, consider various Virtual Offices of political Capacity (VOPC) covering areas such as economic, monetary, trade public safety, virtual office of FDA or the Justice Department. It needs to be emphasized that in no time does our doctrine call for actual civil action, and it needs to be remained in the virtual domain. Point in case is a virtual police chief. It does not call for such a virtual office holder to be in charge of a group of vigilantes. What the plan calls for is a virtual position that can rely on actual cases and information obtained from the public at large, as well as what is obtained under the Freedom Of Information Act in the U.S., or from individuals who utilize their skills for unraveling information, akin to investigative reporters. Because there is no need for a big machinery and office behind such virtual officiating individuals, who presumably would do their important contribution as volunteers, there is no need, at least from the outset, for budgets and raising capital to support VOPC individuals, or at any rate, such amounts would be negligible compared to the non-virtual world.

There are various important element to governing that include health, education, welfare, employment, national debt, budget, and taxation to name a few and various interest groups utilize lobbyist to achieve fulfillment of their interests. However, lobbyist cost money and the one sector that has more of that commodity than the rest is the business sector, and specifically the large corporations. That puts the rest of the population in a weaker position only to find out later on that laws and regulations that benefit the corporations are in essence at the cost of the public. To provide a needed democratic equilibrium without abolishing the important role of lobbyists is feasible with our doctrine. The basic mechanics for it is described next.

There are quasi-virtual positions in our doctrine as well. Those positions are real positions with real mandated powers that encompass individuals that may be appointed by a VOPC, based on public confirmation via voting, or appointed directly by the public. The lobbyist in the doctrine utility is such a quasi-virtual position. Such a lobbyist is not virtual, but rather a real lobbying person with lobbying functions that operates under the directive of the various VOPC individuals who funnel the interests of the public in their elected territory to culminate in actions by the selected lobbyists. Under such a construct, a lobbyist may volunteer for the task, may be nominated by someone else, or may be subject to a vote by the public in any other form that brings such person to the attention of the public in a certain territory. Preferably such individual would be elected for the lobbyist position for a period of time by a majority of public voting, though, other scenarios are possible. The lobbyist would preferably be an individual knowledgeable in certain area of need and have the skills and stature to meet with government officials, educate them on variety of laws, regulations and substance matter, while trying to gain their affirmation of the agenda he or she represents on behalf of those who sent him or her. Travel, room and board for the lobbyist would be covered by funds available to the quasi-virtual lobbyist office, collected from contributions. However, the time spent in lobbying may be volunteered by the lobbyist who would presumably do the lobbying tasks as a part time involvement and find the rewards in achieving important results for the public and the distinction and public esteem that would go with such appointment of prominence, let alone the public gratitude.

Quasi-virtual officials may also mirror other governing positions, such as in the important offices of health, education and welfare, to name just one such example. Toxicity of foods and minimal allowance of certain amounts of damaging substances to humans, as appear in products of a particular entities may be challenged by the quasi-virtual official having the mandate of ascertaining equilibrium between the interest of the public that does not have the monetary ability of interested corporate entities to promote a less-stringent requirement when it comes to products produced or imported for customers by said entities.

In the quasi-virtual group of activities that are operated under a virtual system, such as the aforementioned lobbyist, we articulate the notion of free press that is not motivated by rating and is not dependent on income from advertising from entities that may have an opposing interest to that of the public. We already see independent reporting on the Internet, such as by independent bloggers. However, such reporting is not subjected to the stringent verification that is expected and provided by most responsible media facilities. This is remedied by our utility of independent reporting. The system and method in our case calls for individuals from the public at large to send their report electronically. Every reporting is authenticated by at least one other independent reporting of same event or other piece of information. Such authentication is done automatically by electronic system with suitable software that may include artificial intelligence. Such software validates sender information of the multiple senders for same item and further authenticates non-use of pseudo names used for multiple submission or submission by a party who is in cahoots with a friend or someone else to duplicate the information without eyewitness validation. This system is different from the one where the public can send information to existing media that assign their own personnel for verification and where the editor has the veto powers on release of information that does not seem to agree with the policies of the specific media. Our quasi-virtual media has further Safeguards for material exposure that is safe for all ages, and in particular for children, which is part of the authentication procedure of the system. Further, the authentication also guards against violations of laws and regulations or accepted public moral standards. The site may be divided in its access segmentation or vote articulation segmentation to various age groups. Such division may enable voting for individuals who are not yet of legal age under certain rules of the doctrine utility. Apart from legal age segmentation that may be mandatory for protection of that group, the rest segmentation may be done in decade separation, enabling a somewhat wider group enclosure rather than by specific actual age of the visitor.

The virtual capacity doctrine disclosed here may be utilized both in governing of secular affairs as well as non-secular affairs. Furthermore, since most of the virtual capacity doctrine is processed in cyberspace, candidates for virtual offices do not need to amass large amounts of contributed funds that can thereby be freed for contributions for helping worthwhile humane causes, let alone the fact that they do not create a potential debt to contributors that may be requesting a payback in legislative actions.

We have used the word “mirror” as a metaphor, yet in a sense, the solution provided by the doctrine is a literal mirror of utility, where the protagonists are members of the society elected by the people for virtual positions (and sometimes for quasi-virtual positions) that mirror the actual legally governing positions, though with three major differences: First and foremost, they are responsible immediately and directly to their electoral body of individuals who voted for them; secondly, they are free to exercise any democratic move they desire. To negotiate, reach agreements and design actions with any political figure of any party anywhere, locally, nationally, or globally, as long as that party is also in a virtual office capacity; thirdly, they can reach out to the real and legally governing individual(s) of their own relevant territory to disclose, apprize and advocate endorsement of decisions reached and actions contemplated. Thus, said utility has the objective and capability of acting in the role that amplifies the needs of the people from the humanistic point of view, while giving ample attention to the practical needs of the stockholders via long-range commitment to democratic values and country as well. The political mirror through virtual elements as designed can restore confidence in governing systems and lay the basis for an expanding future for an expanding population of Earth. It goes without saying that the virtual system can and should mobilize voters in real voting for office to go out and exercise their right to vote, and also ascertain that there is no appeasement of the public by exercising populist policies in order to placate the public with immediate rewards of any desires. As such, the doctrine utility may ndertake steps before and during any election times to increase turn out in the ballots, irrespective of the parties for which constituents will cast their vote. Specification of the doctrine utility and the tools are provided below.

Dissatisfaction among the public with their elected officials is not new and the feeling that the game is set from the outset and the system cannot be changed, is rampant among many disenchanted members of the public, visitors on radio and television shows and bloggers. How to bring about legal change and allow young talent to grow and partake in the political system, yet be a true image of the people, while staying loyal to democracy and such aspirations when in office, has not found a suitable solution so far. As a direct corollary, such young human talent that can bring about a desired change lacks the initiative to get involved and partake in reshaping governing bodies and the resulting destiny for all. Young talent may also be age unrelated and simply signify persons yet uninvolved with the political process or establishment.

The doctrine utility disclosed herein strives to build a general non-partisan base in the United States and other governing authorities that represents a majority of interests. Similar entities in other countries that are both specifically dedicated to their specific country, yet cooperate under the umbrella of the doctrine utility, are enabled to joining forces with similar such entities in other countries in order to achieve consensus on and for the good of the people and global harmony. Further, the doctrine utility may provide a base for change in addition to and as a “parallel universe” to the interest driven United Nations that some voices claim to be skewed in its resolutions. In other words the doctrine utility lays the foundation and structure for creating a platform for exchange of ideas aimed at a better world that operates with virtual governments in independent countries and virtual representatives for the United Nations.

The end target is developing true new generations (maybe a breed) of politicians that could lead a future world into a destination of harmonious existence, as supported by the member residents of each country or nation. Such utopia is within reach when harnessing the digital revolution with the power of the Internet and the electronic social networking experience. We describe below the steps, components and procedures of such doctrine.

In Facebook the interaction starts among persons who already know each other and it is the personal bond that begets all sorts of information about members in a group to freely flow and energize activities. In other social networks, such as Linkedin, it is the professional element that binds group members. In our doctrine utility it is a common interest in politics and desire for a better and improved governing system, irrespective of what group one belongs to, to start with; whereas the new groups that are formed around a common interest carry a message and the seed for change. Namely, while in other social networks the aim is personal, even if it is a call for gathering for a demonstration, the doctrine utility is for the benefit of all. Further, it is an operational social networking system, that is fully transparent and achieves mandates from the majority for any action contemplated and has specific goals, mandates, and procedures for achieving the targets set by its members.

Namely, it is different than a common interest of a profession or hobby, because it brings together persons from all walks of personal affiliations, hobbies and professions. Further, and most important of all, is the fact that the doctrine utility has a pluralistic idea behind it, where members ask “WHY” not change what we have to what we want to have, and proceed beyond the discussions and into the “HOW”; taking appropriate steps to achieve such goals. Steps that everyone can suggest, that the majority agrees to and all turn the power of the Internet into a democratic, fully transparent tool. A tool to achieve benefits for residents in one location, supported and inspired by residents in other locations and laying the groundwork for a global community where the betterment of all its inhabitants is a shared interest. Further, it will enable all participants to learn about and to understand others; how to bridge over differences and overcome incongruities and disagreements by open Internet discussions and not by threats and wars as history has sadly shown us only too often.

An opposition party in our doctrine is made of all the virtual office holders and does not intend to take over as a governing party. As such, it could have a profound galvanizing effect on a governing body to really operate in the interests of the governed persons, as otherwise it becomes an isolated party against the “coalition” of its opposing party and the virtual party. Such a virtual party that is really “of the people, by the people, for the people” could be the ultimate watchdog for a governing body because it is devout of any interests in governing itself. Such a virtual party is possible today, with the new communication facilities, such as Internet and mobile smart phones that are further enhanced by social networking and twitter usage.

One of the first questions to come to mind, is whether aspiring politicians may not see and utilize such a virtual party according to the doctrine utility as a vehicle and a stepping stone into influential political life. The simple and straightforward answer is that there is nothing wrong with such a preparatory school for governing; furthermore, it may guarantee that such persons, if successful in their goals, may become more attuned to, and act in, the best interests of the people.

The doctrine disclosed herein lays down the foundation for such a goal by bringing forward and disclosing the system and methods for achieving it.

It would be premature to speculate ahead of time whether there is a need to preempt a potential future situation whereby such a virtual party in the doctrine utility should seek to become a bona fide governing body by itself. It appears from the outset that it would undermine and defy the purpose for its existence. However, room should be left for its evolvement in time to a better and more suitable instrument for the people. As such, potential transformation or transmutation should become, if it ever does, based on open discussions for the public to develop the ideas and vote on them. Therefore, at this juncture, such potential steps are viewed as counterproductive for the intended theme of the virtual party in the doctrine utility.

As is indicated in the mechanics of the doctrine utility, there is a mechanism for selecting a virtual government that appears to mirror office holders in the real government and assigning to such virtual government officials functions that mirror functions of real government officials. It may appear that such assignment of tasks without a real effect on the outcome of the real government is moot and is more of a game than a real operation. However, as becomes apparent from this disclosure, such a notion may be a rush to judgment because the elected virtual officials will have the power to affect change. However, the gaming aspect can be positively utilized as well. Namely, games built to mimic or utilize the virtual party and its activities will only enhance its widespread acceptance when individuals partake in a politically simulated game that depicts the method and system disclosed herein. Thus, such games are hereby included by reference as an integral part of the current disclosure.

Though in a different format, we find that non-secular entities or establishments of any denomination have a hierarchy of officials, processes and actions that do not always agree with the public under their hegemony. As such, our doctrine for virtual officiating may be utilized in the non-secular world as well.

Finally, the virtual doctrine can be extended to other groups apart from secular and non-secular governing entities that have an unseen political protectionism for its members. Such groups may exist within the fabric of day-to-day life. As an example, consider the legal profession with practicing attorneys, where a large percent of the public comes into contact with in one-way or another. It is a known practice for an attorney to demand a signature on a retainer document and an advanced pay called a retainer. More often than not, such an agreement contains an arbitration clause for possible future disputes between the client and the retained attorney. The arbitration clause masks a major disadvantage to the client because the attorneys presiding over any dispute would ultimately side with the attorney who is a member of their profession, even though they do not know the attorney personally. Even when it is clear that the attorney in dispute is wrong and a judgment has to be handed down in favor of the client, more often than not, such judgment is no more than a lip service to acknowledge the wrongdoing but minimizes any financial consideration for the client. Under the extended doctrine utility, a virtual arbitration committee is set up as a precursor for the public at large through their votes deciding the fate of a dispute.

Yet another disadvantage situation for an individual may be a legal arrangement where the legal system erred in processing a case against said individual. More often than not, the prosecutors tend to justify their efforts on said case to safeguard reputation and justify funds spent by turning the said individual into a scapegoat. Namely, said individual is threatened with a much larger foreboding calamity unless agreeing to plead guilty to a lesser, and sometimes a minor charge. It is only human for such said individual to capitulate under the threat. Beyond the wrong moral base for such an act by the legal system, it also puts said individual in a forced perjury situation where said individual has to admit in court the wrongdoing attributed in the plea agreement. This is a blemish in a democratic conduct of a democratic system. Under the doctrine utility, a virtual prosecutor and virtual defense attorney, come together in trying to navigate an honorable and just solution. In a sense, that means a contracted jury body with no stake or interest in the case that can bridge over the difficult situation under the known umbrella of full public exposure for the prosecutors when private agenda drives their actions. Such virtual elements are rather delicate and would need to properly evolve in order to gain acceptance by the legal system and receive the blessings of judges, if not being sanctioned by them.

### BRIEF DESCRIPTION OF THE DRAWING(S)

FIG. 1 illustrates the electronic utility tool

FIG. 2 depicts the operation cycle in the doctrine utility

FIG. 3 illustrates various relations among site functions

FIG. 4 illustrates the interfacing of virtual and quasi-virtual officials, as well as their interaction with real governing officials

FIG. 5 illustrates the interfacing public with the virtual candidates during a nomination process

FIG. 6 illustrates the VOPC versus the RLGO

FIG. 7 illustrates protests, including legislation watchdog public input

FIG. 8 illustrates a daily national political tapestry (a U.S. example) with links to articles

FIG. 9 illustrates media tapestry by territory and segmentation

FIG. 10 illustrates example case of quasi-virtual utility in legal matter

FIG. 11 illustrates body scan with privacy

### DETAILED DESCRIPTION OF THE PREFERRED EMBODIMENT(S)

In asking what form of governing is best, we need first to define from the outset, who are the beneficiaries. Namely, best for whom? If it is for the individual who can reign over others then kingship or other rulership is a viable solution as it serves the interests of the individual at the helm. If it's a theocracy, then a religious form is the solution, regardless of whether individual constituents believe in the same dogma or not. However, if it is the best for the individuals, regardless of their creed, race, gender, forms of belief or other such limiting factors, then democracy appears to be the ultimate. Democracy has evolved through the ancient Greek philosophy to modern times to its embodiment in the American democratic form. Many would argue that even as it is considered to be the most advanced real free form of democracy, it still leaves a lot to be desired, albeit its being the best current evolutional platform. Even so, it leaves communication with other types of governing entities that do not partake in the same form of governing open for friction without a common base for resolutions. Namely, difficulties arise when resolution is to be negotiated when the terms of each party hinge on different motivation, only to result sometimes by agreements and sometimes by friction or war—a war that is fought by the constituents of each governing body, where at least in the case of one of them, is based on bettering one rulership rather than the people. Notwithstanding such fact, even in a proper democratic governing, we find people at the helm of authority making decisions on behalf of their constituents who go to war without having the proper format to oppose endangering their lives for misjudgments of the authority.

Let us examine another element in a democratic government. Consider a person that is incarcerated by a judicial authority that misinterprets motives and actions because its clerical obedient servants let their personal inequity create improper judgments. In a democratic system, such as in the United State, we have the notion of the free press as part of our (amended) constitution that can come to the aid of the common citizen and expose the injustice. However, even that form of tool chiseled in the constitution to keep the governing in line for the benefit of its constituents does not always work, because it is a single journalist who fights that war and it is his or her own ideas that receive airing in the media, leaving the majority of the constituents to express concurrence or objection only after the fact, as can be witnessed when their opinions are counted in various polls. Thus, such polls are after the fact and have very little power to affect a situation. Part of our doctrine borne in the disclosed system and method utilize contemporaneous polls as a tool.

Namely, it is further the aim of our doctrine to change and improve a situation by utilizing the democratic tools it ushers in. It enables a contemporaneous and timely true voice of the people, to affect actions and decisions. Further, it is aimed at enabling constituents of any regime all over the globe to come to agree on issues and thereby avert wars that bring calamity, death and sorrow to survivors. This is the “WHY” of our doctrine; the “HOW” is provided in the method and system disclosed in this application.

“WHY” and “HOW” are elements articulated in the book “First Start with Why by Simon Sinek.

The major encompassing tools of achieving the goals declared herein is at least one web site(s) and/or at least one server(s) open for communication to any member of the public at any age, with appropriate shielding of children below legal age.

We will discuss below in detail the major tool of said at least one web site(s), its components, entries and contemporaneous voting by readers on input creating a dynamic polling of opinions, reflecting positions and how and if changes occur and the basis for such changes. Voting will also be utilized for electing individuals to a variety of offices.

There are two major components to the product and service of our system and method: (1) The Our Voice Counts (“OVC”) segment, which enables elected officials to have the benefit of opinions across the board from constituents and others in capsulated form; and (2) The Alternative Function Voice (“AFV”) segment, allowing the creation of virtual governing bodies to exist in parallel with the elected official bodies, thereby enabling a future migration to full exchange of governing powers or improved current functioning under the potential “threat” of otherwise being replaced by the virtual governing body.

All said segments operate while utilizing electronic communication with certain rules that guaranty efficiency and a platform for a large group of voices (metaphorically speaking) bolstered by contemporaneous real-time polls.

Initial rules of exercising our doctrine via the method and system maintain that:
All communications to the OVC and/or AFV Centers are by texting with no voice. (Except for blind persons whose voice is converted to text and text converted to voice)
All communications, regardless of their form of delivery, abide by a maximal length, such as a 140 characters (as in Tweeting).
No slurs or abusive content is permitted
No promotion of commerce is allowed in the content (except proper advertising, outside the content)
No rooting for or supporting any party's ideology or standing is allowed. (ideology or standing expressed may be identical to an ideology or standing of an existing political party but no reference to such political party or connectivity to it is permitted)
No campaigning for any specific political party is permitted.
Video submissions, such as in You Tube, are permitted under the rules provided.

There are two types of communications in the system. Short communications, where each particular one does not exceed a pre-determined number, such as 140 characters and reasonably longer communications without length limitation that are channeled into a different “in depth” segment of the system as presented to all. Thus, the list below, that may not be comprehensive, contains entries that could be utilized either independently or in combination with at least one other entry in the list:
The interactive segment
The in depth segment
The poll segment
The voting segment
The nomination segment
The Question & Answer segment
The reporting segment
The comparative segment
The grading Segment
The real-time (and preferably contemporaneous) public opinion segment
The public segment for change, modify or upgrade the system
Database(s) with search algorithm(s) engine (by at least one of subject matter, topic(s), word, sentence, name(s), number(s), previously utilized material, entity name(s), any entry enabling locating of desired material or quote and combination(s) thereof.
Input to the site, as well as output form it may be in at least one of a text, voice, video and tactile, as well as any form suitable for persons who are at least one of hearing and sight disabled. The site may also utilize Touch Language.

The doctrine utility has mechanical ramifications beyond electronic communications and as such, proper security measures need to exist for nations and individual countries due to the ability for individuals to post material and empowering full transparency. To emphasize security conscientiousness, while maintaining transparency and anonymity, such measures extend to individuals from at least one of a national and international travel. As such, the doctrine utility includes a solution for body scans, such as in airports, bridging among security, individual rights for at least one of a privacy and anonymity and the right of the public to know, by providing an improvement to currently existing system of body-scans at airports. Said body scan breaks down the scan into multiple scans as discussed below.
It is Proposed to put in a cartable article, such as a passport, an incidental (and removable) digital identifier, such as a barcode at check-in procedure with security
Said digital identifier mark on such an article as a passport has no ID or Name and neither would a name appear on the scanner, nor a scanned picture. The only connectivity to the person being scanned is at the initial procedure station when the digital identifier is provided and associated with the individual being granted same
The scanning system is divided into at least two separate scans, where said two separate scanning units are physically separated from each other.
One scanning unit scans only the body of the person without the head, whereas the head is scanned separately by another scanning unit that cannot scan the body but will receive same barcode or other digital identifier as the one received by the body-scan unit, enabling correlation between the body-scan and the head-scan, while not combining the two scans into a single image.
No security personnel can see the resulting connectivity of digital identifiers, such as the barcode with a combined face and body, EXCEPT when there is a security issue, such as when explosives are discovered.
   That way the scanning can be as invasive as needed, yet limiting personal exposure and maintaining individual privacy and anonymity with comfort to the scanned persons, such as passengers.

### DETAILED DESCRIPTION OF THE PREFERRED EMBODIMENT(S)

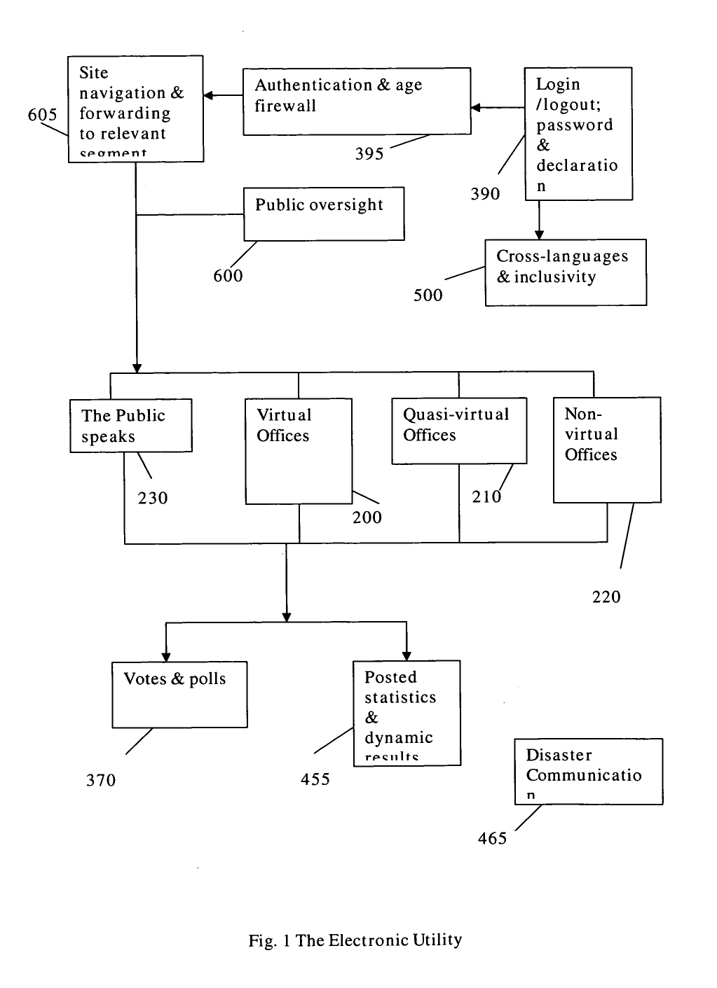

Referring now to FIG. 1, it illustrates the electronic tool through the web site utilized in creating the instantaneous and dynamic forces by interacting individuals to achieve the goals set forth herein.

Individuals may either register to, or login to the site in (390), providing a password and either signing or affirming a declaration; the declaration affirms their being a human being (in contrast to robots or other entities, such as an animal represented by the individual), promising always to speak (sign or tactile) the truth, not to manipulate and not to represent anyone else but themselves, as well as to access the site only under one ID. Authentication takes place in (395), including appropriate age of site visitors. Upon login or registration to the site, individuals are informed and may enable communication facilities suitable for them in (500); such as utilizing text, sign language, or tactile delivery, or using Touch language. Subsequently, site visitors are channeled in (605) to the appropriate segment for them, either by request or by the technology utilized on the site to determine such destination. Hate mail may not go beyond that step that channels it all for aggregation and disposal; likewise, pejorative language may cause an input to be automatically returned with a note for redraft. Furthermore, the doctrine utility may strive for and enforce decorum on all communications from and to the public, and may utilize artificial intelligence technology to intercede and at least one of a return communication requesting adherence to decorum, automatically edit communication to ensure decorum, and utilize any other form to ascertain its daily issues appearing in (400) effective mandate. Personal outbursts that violate decorum may have a place in personal social network, such as Facebook, where an individual can release feelings but should not be enabled in the doctrine utility. Public oversight in (600) may enable the public, either through a committee elected for such purpose and/or individuals from the public to ascertain that all functions and operations of the site abide by its spirit, code of operation and interests of the public. The site management may exercise its own sight oversight as well. Once an individual has been authenticated in (395) and navigated further in (605) said individual may end up either as dealing with any of the virtual elements in (200), any of the quasi-virtual elements in (210), or the non-virtual elements in (220). Otherwise, all other elements are grouped under the public voice in (230). The virtual elements in (200) may be such elements as related to election of an individual for a political office of virtual capacity (VOPC), such as a virtual, senator, president or prime minister, or discussions related to it. It may also encompass participation in a passive viewing of a debate between two VOPC individuals or communicating information to them. The quasi-virtual elements are similar in their activity nature and pertain to individuals before or after election to such positions. Among such positions are the position of quasi-virtual lobbyists and quasi-virtual media persons in our doctrine and utility. Non-virtual elements in (220) could be real legal governing officials (RLGO), as well as other elements related to functioning bodies, such as UNRA, UNICEF or the Clinton-Global-Initiative. Public vote and polls in (370) is collected whenever relevant, whether it is for voting an individual to a virtual or quasi-virtual position or expressing agreement or disagreement with material appearing on the site. Statistics of all such votes and polls are displayed in (455), which may carry dynamic presentations of updated results as they occur in real time. Unrelated to the doctrine is a public service that informs site visitors in (465) of any pending or existing disasters and communications regarding handling it.

As an annex to the foregoing FIG. 1, we provide a listing 1A appearing in Appendix A, showing the site index that may contain at least one of the entries in 1A and enable site navigations. Explanation of the entries in said listing 1A follows.

Appendix A illustrates partial listing of the site navigation in (605) that may represent a particular site index that may change from time to time. “In Your Face” in (A 10) illustrates questions and answers to politicians that are capsulated in short postings by the herein described rules, such as 140 characters limit per posting and the politicians response next to it. The politician may receive the question with a short time lead period ahead to enable thorough thinking before posting a concise representation of a well thought answer that may again be with the same said limited number of characters per answer. Questions may be first posted on the site by visitors to the site, who may be individuals from the public and voted for selection of the “best” question ending being the one with most votes that is submitted to the politician; the politician may be at least one of a RLGO and VOPC. Further, said selection may be posted with a vacant space allocated for the response until it arrives and posted that may also have a clock presenting the time elapsed until a response arrives. Finally, a list of unanswered questions after a cut-off time for response may also be presented and may carry the name of the official figure that did not respond. Voting on the politician' answers of concurrence or negation by individuals visiting the site is an integral part of each such response, as is the presentation of the results that may be dynamically represented. The public may further respond with a comment to the response, which may be rated by a vote for concurrence or negation.

“Ask Your President” in (A 20) may be a weekly question that may be a single question asked the president as a question that may be selected in a similar process to the selection described in (A10) and the answer posted in a form that may be similar to the format in (A 10), as well as allowing visitors to the site to agree, disagree or post their views, where voting, polls presentation that may be dynamic and posted in a form and structure that may be similar to that in (A 10). A compilation of questions to and answers from the president may be posted for all the past postings in at least one of a weeks, month(s), and year(s). Similar posting may be instituted for the questions and answers in (A10).

“True or False” in (A 30) is a combination of at least one of the site management and visitors to the site presenting statements made that may be preferably related to political issues and posting for proper veracity statement after researching it and verification of said statements. Said “True or False” in (A30) also measures the public belief in the statements and their potential veracity determined or alternative debunking, as well as such belief in the veracity or debunking where appropriate, by voting at least one of a “True”, “False” and other voting criteria, by individuals visiting the site who see the posting. Further, with the practice of the site structure, such votes may be posted and may be dynamically changing up to the removal of said specific case from posting.

“(Most) Relevant News of the Day” in (A40) provides capsules of news from the day, where the reader is prompted to rate their importance and vote for the most important news piece. The purpose of it is basically educational and informative, where visitors to the site may become aware of important news even if they are mostly involved with personal or social issues, as it is the intent of the site to allow connectivity to and from social networks, such as Facebook and Linkedin. Said purpose may also extend to creating more involvement of the public with the site and its goals. Said site visitors' rating may be in at least one of a “YES”, “NO”, and other form clicking, rating according to a scale, such as 1 to 5 or 1 to 10, and a limited character response providing reason for the rating. One method of said visitors' rating may be structured as follows: (1) visitors rate the relevance on the base of 1 to 10. (2) All those news posted receiving 5 or above rating number are kept on the site up to the limit of the “top 16” postings. (3) At the end of the day (time predetermined by the site management and appropriately posted), the top rated three postings survive and are posted with the names of the individuals initially posting them. Further, the last “winning” individuals whose posting were acknowledged with their names may have said acknowledgement posted in their social network group, such as Facebook or Linkedin. Polls identifying number of votes and their possible dynamics may also be posted on the site. The pictures of individuals selected for submitting a question to an official or the president, such as in (A10) and (A20) may also have their picture posted next to the question and posted in their relevant respective social network. Likewise the picture of the answering official and the answering president may be posted next to their respective answer as well, when proper authorization has been received for any and all such postings of pictures.

“Donation for a Cause” in (A50) is a public service of the site that may be split for more than one segment. (1) First and foremost is the segment of helping and assisting the needy, where the site has a page for posting at least one brief massage (e.g., no more than 140 characters) regarding a specific need, such as a young boy who needs bone marrow transplant, where a click by a visitor may provide instant link to potential donor or intermediary to a donor, or a young girl with cancer who needs to collect money for her operation and clicking by a visitor may enable immediate donation in a form such as PayPal, FCT, debit or credit card. If a specific amount of money is required, then the number may be posted, as well as the current amount generated and may be changing dynamically on the site page. Number of contributors may similarly be posted, as well as random names of donors posted (with their approval) and a link to their social network group, such as Facebook or Linkedin, informing their co-members of their contributions. Further, a link may be provided for said co-members to participate in said contribution for a cause. All such postings may undergo authentication to ascertain validity, discovering fraudulent attempt and scams; and (2) Political contribution online may also be facilitated utilizing similar measure as mentioned here. While the former may be a free public service the latter may be a commercially utilized function and may be relegated to the back pages of the site.

“Polls Summary Page” in (A60) shows at least one of a (1) Summary of various polls in a particular day, (2) same summaries relevant to the previous day, (3) capsulated summaries of the week, (4) capsulated summaries of the Month, and (5) capsulated summaries of the previous year.

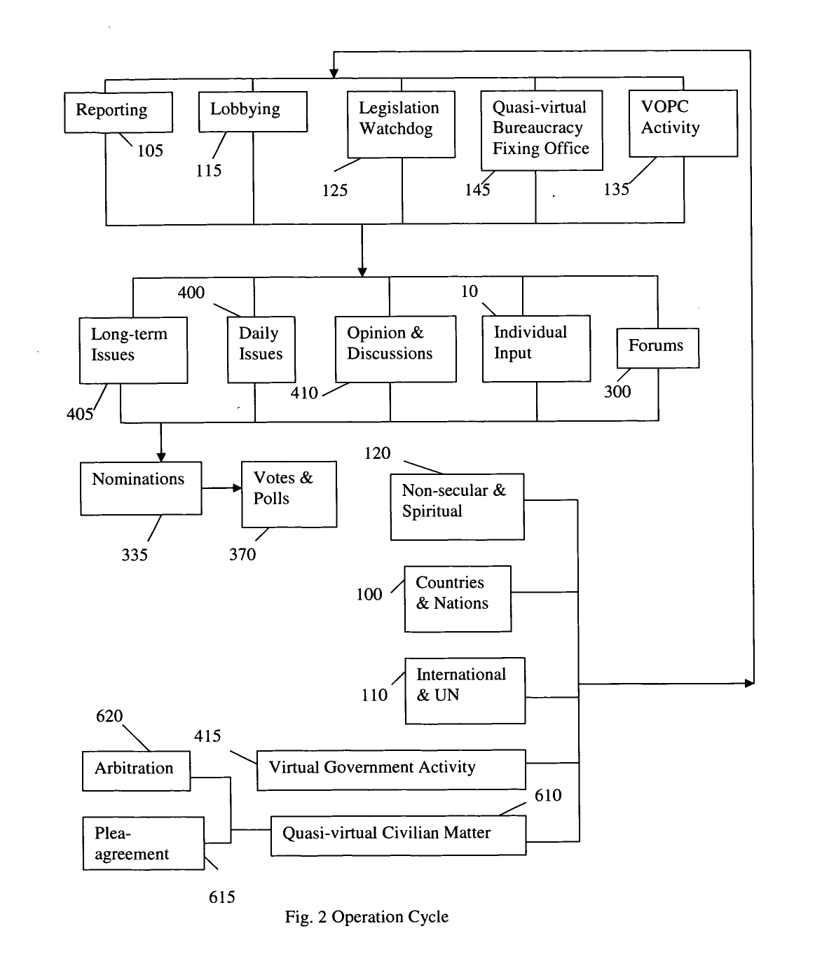

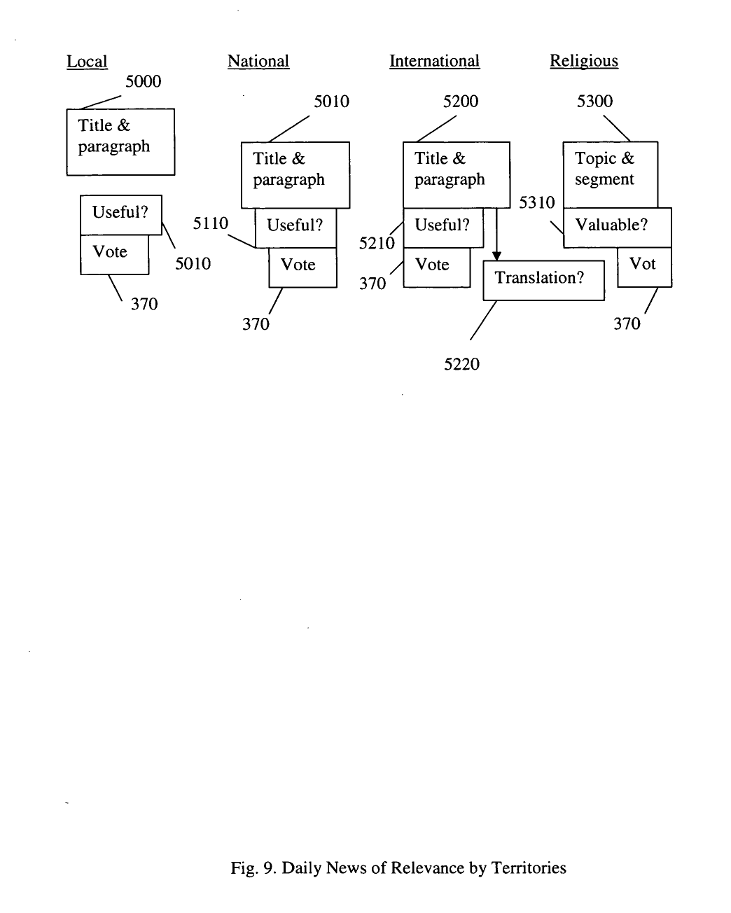

FIG. 2 illustrates some major components and cycles in the operation of the disclosed doctrine utility. Activities related to virtual office holders in (135) may cover background information and achievements, activities involved, communication with the public, as well as with office holders of real governing positions. It may also cover participation in Forums in (300), as well as in Opinions and Discussions in (410), or in the Daily Issues in (400) and the Long Term Issues in (405). Namely, VOPC activity in (135) shares with the public activities of the elected individuals to virtual offices, as well as receiving ideas, suggestions and criticism from the public. Reporting in (105), Lobbying in (115) and Legislation Watchdog in (125), all may further be involved in the same activities in (300), (10), (410), (400) and (405). The Lobbying in (115) relates to the activities, including selection and operation of the lobbyist who holds a visible public quasi-virtual office. The lobbyist may also receive directives from the public in (410) and/or in the forums in (300), for representing public interest, be subject to public scrutiny and fulfill the duties of the office chart held. The Legislation Watchdog in (125) is a quasi-virtual position that mandates careful reading and comprehension of any bill drafted for and/or by congress and bringing it to the attention of the public. Portions of the readings from the proposed legislative bills undertaken by the legislation watchdog in (125) may also be reported to the public in (105) and subsequently undergo discussions by the public in (410) and/or in the forums in (300), resulting in voting specific directives to the legislation watchdog who receives it back in the cycle in (125). Office holders of this quasi-virtual position do not undertake activities to change any language found to be incompatible with public interest. The role of such quasi-office holders is restricted to understanding the drafted bill and bringing it to the attention of the public. The request for changes in the drafted legislation may come about either by the lobbyists in (115), the various VOPC individuals, or directly through the reporting process or the public. The Quasi-Virtual Bureaucracy Fixing Office (QVBFO) in (145) strives to reduce bureaucracy in governing operations by utilizing suggestions from the public. The QVBFO may either initiate on its own a targeted governing office for approach or may do so based on requests from the public, where the highest number of votes determine the next targeted governing office. The Reporting in (105) represents various reporting, including the quasi-virtual media tool of the doctrine utility. Input mostly from the public in a variety of forms results from a variety of sources including miscellaneous input in (50), the reporting in (105), the lobbying in (115), the legislation watchdog in (125), the QVBFO in (145), and the various VOPC holders' activities in (135) is further a base for public interaction with the issues involved such as in Opinions and Discussions in (410) or the Individual Input in (380). Daily issues appear in (400) and cover interactivity by visitors to the site and a summary opinion of the site management reflecting only the opinions of the majority as collected throughout the input activity to the site and that might be bolstered by the polls collecting the contemporaneous votes of visitors expressing opinions as they interact with material on the site. Likewise, Long-term Issues in (405) depict issue with long-term effects or interests. Due to the limited amount of data, such as 140 characters per input allowed for specific designated segments of the site, or any other similar restriction, a rapid flow of input and reaction with potential voting is enabled. There may be blurring of boundaries between the short-term or daily and the long-term, such as in funding an important public need and its fiscal long-term impact. The rules in the doctrine utility are flexible enough to enable sliding from one to the other, or even mix them when appropriate. FIG. 2 further illustrates through the VOPC activity in (135) the virtual offices paralleling the existing governing situations, which is the platform for virtual office seekers or individuals elected for a VOPC. It may also represent a platform for the future cadre of leaders as articulated or a cadre of challenging virtual-governing group. Namely, VOPC contenders may group in different groups as the doctrine utility evolves. Forums encompassing discussions by interacting participants, covering a variety of subjects and issues is shown in (300). Forums in (300) can come about from a variety of initiating sources. They can be started by the site management in (605) in FIG. 1, by any member of the public, such as an individual input in (410), or by any of the virtual or quasi-virtual office holder, such as in (135), (115), or (145) respectively. Notification of an upcoming forum or an existing one may appear on the site so that members of the public and others can join in. Nominations for various virtual and quasi-virtual offices are shown in (335) and voting for the nominated parties appear in (370). FIG. 2 further illustrates the disclosed doctrine utility that goes beyond individual activities and allows also for assembly of those with a common denominator, such as the virtual government activity in (415), where holders of various virtual positions may come together to discuss issues of common interests and/or reach agreements on various actions to be undertaken, and where said group may be also subject to information from various quasi-virtual office holders, such as the lobbyists in (115) or legislation watchdogs in (125). Said doctrine utility goes beyond the local arena, such as state and national interests and includes also Countries and Nations in (100), which may duplicate in their construct and activities those discussed herein for the local and national. The United Nations in (110) also embodies such entities as UNRA and UNICEF, or the “quasi-UN” Clinton Global initiative. Similarly, International and United Nations interests, activities and actions, as well as potential mirroring of the local and national virtual and quasi-virtual utilities may take place. Finally, the doctrine utility may be utilized also in non-secular and spiritual activities and situations in (120) with the same principles and layout disclosed herein, as tailored to the specific needs of said non-secular and spiritual entities that may include such entities as a specific church, an Islamic entity, the Dalai Lama or the Catholic Church with its center of influence of the Pope and the Vatican. It should be noted that a variety of activities described in FIG. 2 end up in votes and polls in (370) and then progress to feed back into such situations ads lobbying in (115) or VOPC activities in (135). Likewise, the group making up the discussed elements in (100), (110), (120) and (415) also do feed back as discussed. The daily issues appearing in (400) may contain input from site management and/or come from the public input in (410). Daily issues may also include the “Question of the Day” that may either contain a question from the site management or a selected question from the public in (410). Requests for “Question of the Day” in (400) may be selected by public vote in (370) and the ones receiving highest numbers are selected for it. Any requests, suggestions or voting by the public may have a posted cut off time. The quasi-virtual civilian matter in (610) represents various cases of quasi-virtual involvement in civil situation that may be legal situations. Any said legal situations may be at least one of a civil and criminal matters. If we take as an example the situation of quasi-virtual involvement in a plea agreement in (615), then FIG. 9 represents the process. Another example of the civilian matter in (610) is the arbitration in (620). Said arbitration calls for at least one quasi-virtual representative(s) and preferably two to join in the panel of judges in an arbitration case. Such a panel that may then be composed of two attorneys, one civilian and two quasi-virtual representatives may offer a more balanced decision by the judging panel, where the opinion of the civilian cannot be ignored to reach a decision in favor of the attorney sued by the client.

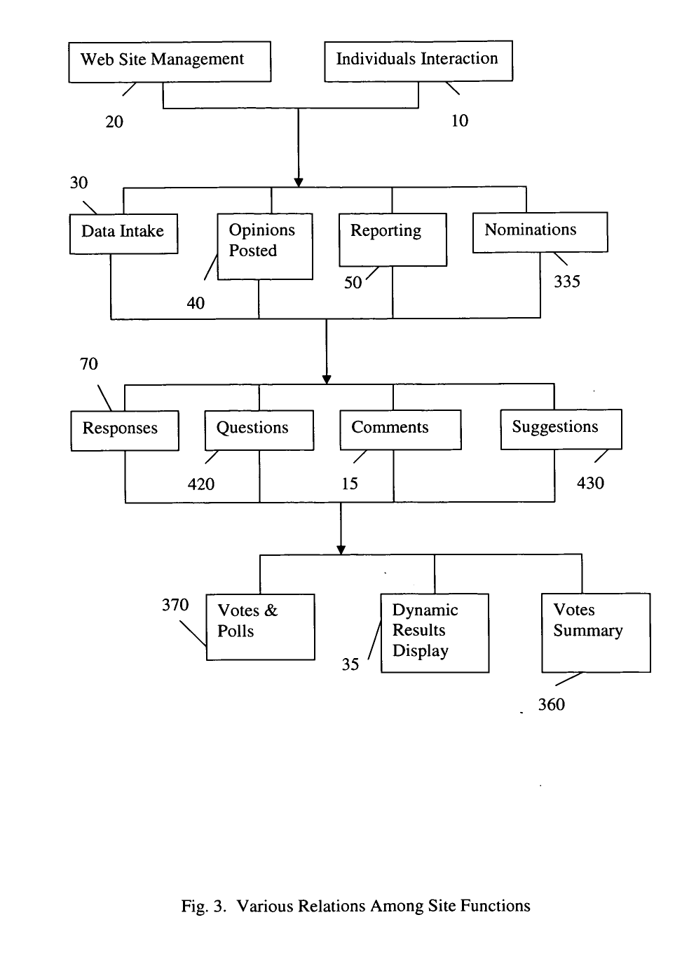

FIG. 3 illustrates various relations among doctrine utility's site functions. Input to the site may come from individuals interacting with the site in (10) or website management in (20). Either way, such input leads to such destinations as data in take in (30), opinion(s) posted in (40), reporting in (50), or nominations in (60). Said destination(s) may beget at least one of a response(s) in (70), question(s) in (420), comment(s) in (15), or suggestion(s) in (430). At least one of the above may end up in votes in (370) and subsequently in at least one of the dynamic results display in (35) and the vote summary in (360). Nominations in (60) include nominations for virtual offices such as virtual senators, nominations for quasi-virtual offices, such as for lobbyists or for a holder of virtual head of the office of health education and welfare, or the food and drug administration. The nominations in (60) may also include quasi-virtual offices that do not mirror real official governing offices, such as the virtual office of the legislation watchdog with the main function of going over proposed legislations and study them carefully to ascertain that they are fully transparent to lawmakers and not containing any hidden meaning, as well as being transparent to the public. The office of the quasi-virtual legislation watchdog may issue alerts to any insufficiencies or potentially ill-affecting public interest of legislations when appropriate. Reporting in (50) also include variety of other reporting and specifically including reporting of events, occurrences and situations for a real reporting media vehicle that may be established and run by the machinery of the herein presented doctrine utility and abiding by its rules. Responses in (70), questions in (80), suggestions in (90), and comments in (15) are mostly resulting as reactions by the public receiving the information provided above that may lead to personal opinions voted and expressed in the votes and polls in (25). Dynamic presentations of votes and polls are shown in (35) that may be contemporaneous to several ongoing functions and may be dynamically changing in real time and so presented to the public expressing its input and others. The process in FIG. 1 is a dynamic and cyclic process. Namely, Site visitors who read postings in (40) can vote their opinion on the material in (25) and/or respond to the input in (70). Visitors to the site who read said response appearing in the postings in (40) may respond to said response in (70) and vote their opinion in (25). The votes in each category are summarized and displayed in (45) that may be contemporaneously to the postings in (40). Likewise dynamically changing polls are displayed in (35). Summaries of voting, whether they have specific interest, of general value, or selected summary or quotes from inputs of any form appear in (360), where even there, there is the option to vote for or against in (370).

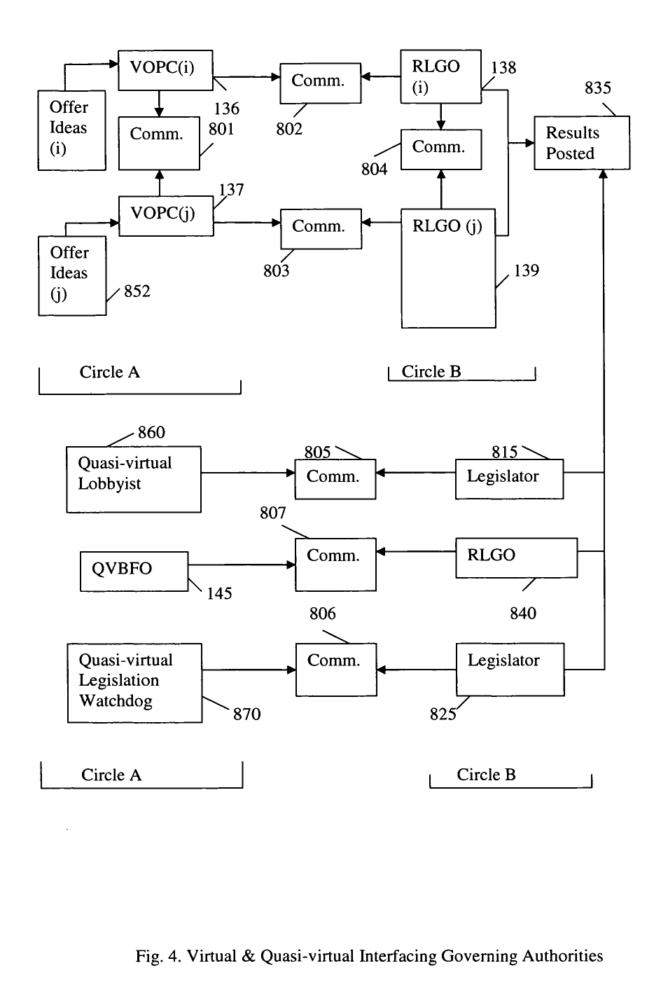

FIG. 4 illustrates communications between constituents and their elected VOPC representatives, as well as communications between VOPC representatives and RLGO representatives, all with full transparency. A VOPC(i) in (136) initially communicates in (801) with another VOPC(j) in (137) who represent a different interest, region or country for the purpose of trying to resolve a difference of opinion. The communication in (801) is open to the public for passive viewing. While the public may be watching said passive viewing, a constituent may call in (851) his or her virtual representative in (136) who is engaged in said communication in (801) and offer information, suggestions or other data that is privy only to said representative in (136). Likewise, a constituent of said another VOPC(j) may communicate in (852) with said relevant another representative to offer his or her ideas and suggestions for the communication in (801) that can be seen only by said another representative VOPC(j). The results of the communication in (801) may be communicated to the relevant RLGO in the respective territory. Namely, VOPC(i) communicates in (802) said results to RLGO(i) in (138). Likewise, said another VOPC(j) in (137) communicates in (803) said results to another RLGO in (139). Subsequently, RLGO(i) may communicate in (804) with said another RLGO(j) in (139) to discuss endorsement of said agreement by the VOPC(i) and said another VOPC(j).

FIG. 4 further illustrates communications between other virtual or quasi-virtual officials in Circle A of FIG. 3 and RLGO representatives in Circle B. For example, the lobbyist in (860) of circle A may communicate in (805) with the pertinent RLGO legislator in (815) and a legislative watchdog officer in circle A may communicate in (806) with said legislator in (815) or another legislator in (825). The QVBFO in (145) communicates in (807) with the RLGO in (840) whose office is targeted for the task in order to facilitate access to the office operation. After studying the issues, the QVBFO connects with the public for assistance. The public proposes a simple, straightforward procedure for enforcing specific regulations that is voted for majority acceptance. Subsequently, the (VOPC) held by an elected individual in that jurisdiction, proceeds to obtain endorsement from said RLGO in (840) who can take it from there for activation.

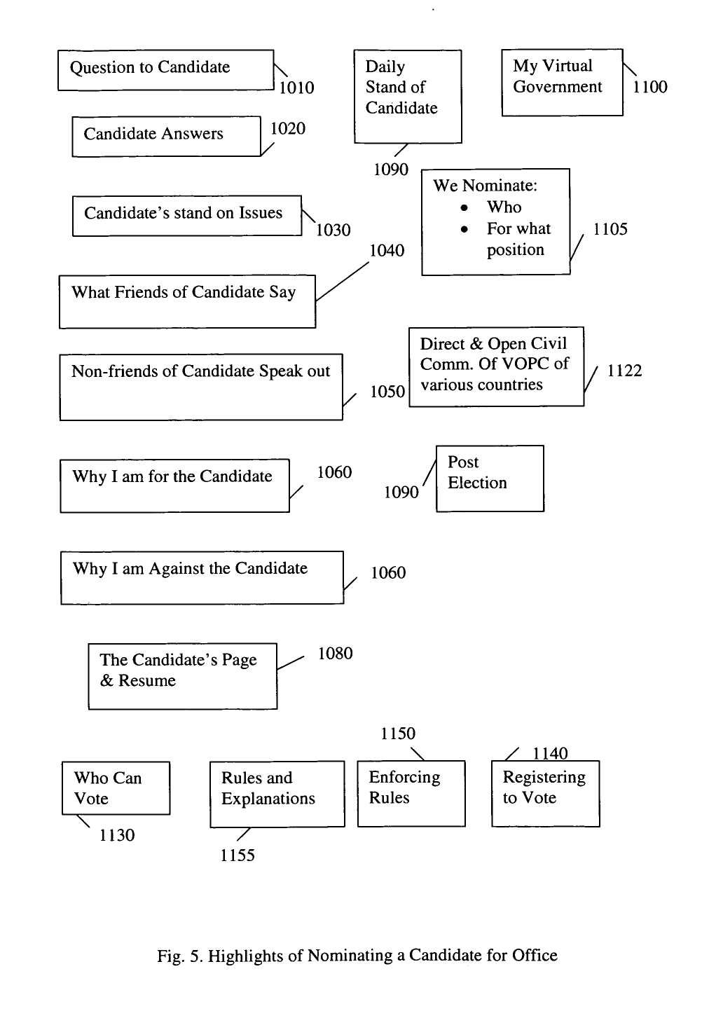

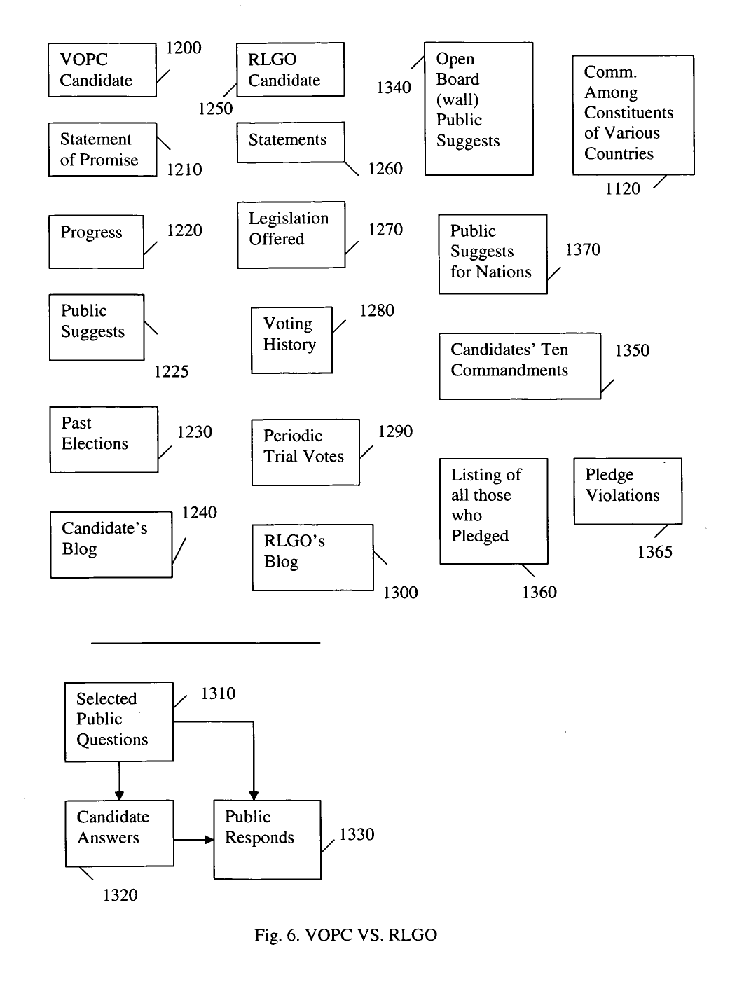

FIG. 5 illustrates the virtual elements in (200) of FIG. 1, where all entries by candidates and visitors to the site are of limited character length, such as 140 characters, except in such cases as the candidates' page in (1080) that may contain a resume for at least one candidate(s). Questions to the candidates are shown in (1010) and the candidates answer in (1020). The candidate stands on issues that may be a single issue per posting is shown in (1030) and a daily stand of at least one candidate is shown in (1090). Such daily stands may be issues relevant to said day, happenings or earlier days, decisions or actions of the governing entity, such as the U.S government. Friends of the candidate that are so declared by virtue of participating in that section, appear in (1040) where it allows speaking on behalf of the candidate. Similarly, those defined as non-friends of the candidate can post in (1050). Actual campaigning for and against the candidate appears in (1060) and (1070) respectfully. Visitors to the site may suggest persons to become candidate, including the candidate himself or herself, that so identifies him or her or appear in (1100). Information of past elections by visitors of candidates may appear in (1110). Rules as to who can vote are shown in (1130), and may include, registered individuals, age, residing in a specific location, and other elements where for example any party to whom an electronic “point” or signifier is attached, even when voting, such vote is not counted. The rules and explanations appear in (1155) and may be constructed with input from the public without adherence to the rules until established in order to allow input from individuals who desire to vote and wish to ascertain eligibility. Registration for voting appears in (1140). Enforcing the rules is shown in (1150). Direct and open and civil communications between elected alternative virtual governing board officials is shown in (1122), while discussions among their “constituents” is shown in (1120) (in FIG. 6).

FIG. 6 illustrates VOPC versus RLGO in the interactive public eye (as represented by visitors to the site) taking place and covering interaction with the Alternative candidates before and after their election. The candidate as represented to the public is shown in (1200) and as an elected virtual Governing member is shown in (1250). His/her promised statement to the public that may be at least one of a permanent statement and a variety of promises that may be posted from time to time appears in (1210). Voting related to it, such as has it been achieved, is progress satisfactory is shown in (1220) and any suggestions by the public as related to it is shown in (1225). Number of persons voted in the past versus current dynamic voting is shown in (1230). The candidate's blog for the site that has limitations, such as one a day and length such as one or multiple 140 characters is shown in (1240). Statements by the elected official are shown in (1260), legislation offered in (1270) and polls of voting history that may include dynamic current response form the public to the posted offered legislation is shown in (1280). Periodic trial votes to gauge public sentiments on a variety of issues is shown in (1290). Similar to the candidate's daily blog we also have the elected official daily public blog in (1300) under the same rules as the candidates in (1240). Direct communication among candidates on one country and candidates in another country is shown in (1120) that may include at least one of candidates running for an Alternative virtual Government position and those having already been chosen for it. Clearance with local authorities where appropriate in order to safeguard national interests will be part of the training given any candidate prior to such contacts. Said communications in (1120) will be open to all to see on the site.

Selected public questions to candidates that may be chosen under the same selection rules as questions for the president is shown in (1310) and the candidate's answers are shown in (1320). Dual polls are shown in (1330) for public (i.e., site visitors) voting after postings, such as agreement or disagreement with certain questions, as well as answers. Open Board is shown in (1340) where, such material is posted as upcoming events or being in progress or suggestions by the public to the management of the site.

The “Ten Commandments” of the site for all candidates and elected officials is shown in (1350) where they each pledge such statement, as (1) All that I will do will be transparent to the public; (2) my allegiance is first for my country and then for other states; or (3) I am a human and can make mistakes but will acknowledge it when I find out. The public will be helping in crafting said pledge as is shown in (1335), under the site process of open debate on the site with appropriate voting to select each pledge. A list of those candidates and elected officials who signed the pledge, committing to it is shown in (1360). Possible pledge violations are shown in (1365) where they can be refuted or bolstered with interactive public participation. Punic suggestions for nations and/or their candidates appear in (1370) where the nations and the suggestion of r it are listed. Public debate with voting on such suggestions may be cross-nations involvement. It is the intent of the entries in FIG. 5 that no campaigning may be allowed, though the issues speak regarding such essence.

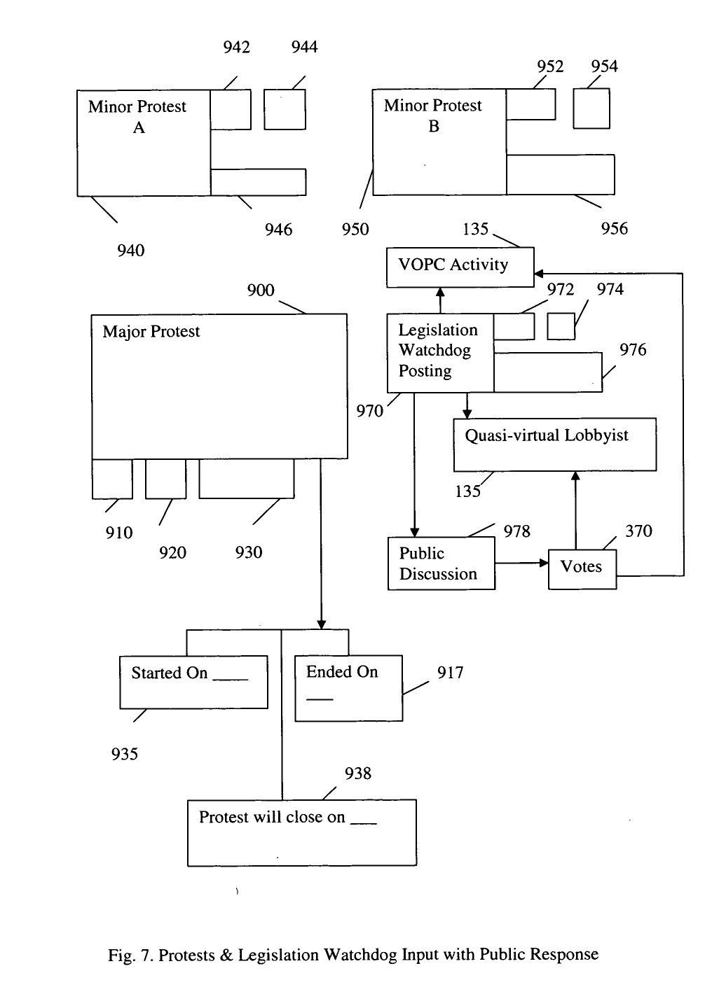

FIG. 7 illustrates protests by the public, including the legislation watchdog postings and opinions, the relevant statistics and timings. A major protest appears in (900) and may be chosen to be posted in a variety of ways that may be at least one of a site management decision, votes by visitors with the mechanism to select the most voted for, such as is used in selecting a question for the president appearing herein, or any other suitable method. Visitors voting “For” will click on the button in (910), those against on the button in (920) and the vote results will be showing in (930). Time for when major protest started is indicated in (935) and its ending time in (938), while in (937) it will be specified when it actually ended or if it is still open. The protest period may be any selected time that can last form hours, to days, or any span desired. A graphical representation of the votes producing the poll may be shown in (939) and may be dynamically changing in real-time according to input from site visitors. Some minor protests may appear such as in (940), and (950), with their respective “For” votes in (942) and (952) and the “against votes in the respective (944) and (954). The respective polls of said votes may appear respectively in (946) and (956).

FIG. 7 further illustrates postings by at least one legislation watchdog quasi-virtual officer(s) in (970) that may relate to major protests. Votes for the proposed legislation wording appear in (972), against it in (974) and statistics summing up the votes in (976). The public in may discuss the postings in (978) while voting in (999) related to material posted by the public in (978). Said posting in (970) may lead for the involvement of the quasi-virtual lobbyist in (115) or to VOPC activity in (135).

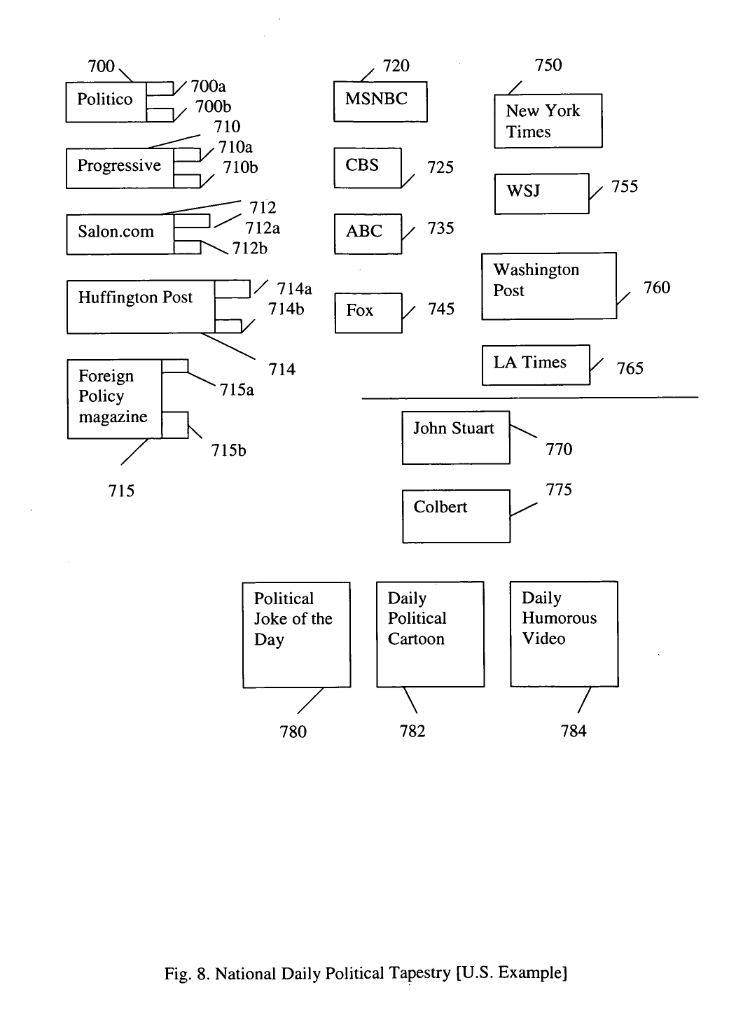

FIG. 8 illustrates the National Daily Political Tapestry [a U.S. example] that preferably is provided to the posting by at least one of the entities composing the tapestry but could also be provided by site personnel or the public. In the latter case, such postings would first undergo authentication and verification by the site personnel and management. Said posting may adhere to limited length posting, such as 140 characters enabling rapid absorption by readers and eloquent thoughtful presentation by the posting persons. The material therefore is grouped and presented from the sources that only be an example and may contain less or more sources, as follows:

### Group A:

From at least one of a Politico in (700), from Progressive in (710), from Salon.com in (712), from The Huffington Post in (714), Foreign Policy Magazine in (715), and at least one other source(s).
Group B: From at least one of a MSNBC in (720), from CBS in (725), from ABC in (735), from Fox in (745), and at least one other source(s).

### Group C:

From at least one of a New York Times in (750), from the Wall Street journal in (755), from Washington Post in (760), from LA Times in (765), and at least one other source(s).

### Group D:

From at least one of a John Stuart in (770), from Colbert in (775), and at least one other source(s).

### Group E:

May include at least one of a “Political Joke of the Day” in (780), a cartoon in (782), and a humorous video in (784).

Each of the entries in each of the groups may enable response by site visitors, such as in (700a) and also may enable voting as related to said postings, such as in (700b).

As is the practice of the doctrine utility shown in the site, said Daily Political Tapestry may be presented by at least one of a text, video and tactile form and response by visitors may be by at least one of a text, video and tactile form.

Said usage of video is not limited to said Daily Political Tapestry and may be used for any and all posting on the site, such as, at least one of a at least one individual(s) from the public, at least one public official(s) or person with authority, at least one person(s) nominated to office by public official, and at least one VOPC(s) or quasi-virtual VOPC(c). Said at least one posting(s) may be for at least one of a at least one question(s), t least one answer(s), and at least one comment(s). Said video may be any video known in the art, such as recorded by a person or an instrument and uploaded to the site or video used in commerce.

Besides championing the political doctrine utility, the site may choose to expand exposure to other areas of life for the benefit of its visitors. As such, the daily tapestry may be expanded to include other subjects in capsulate form. For example, Monday may be dedicated to sports tapestry; Tuesday dedicated to advances in medicine; Wednesday may be dedicated to scientific discoveries; Thursday may be dedicated to health and nutrition; Friday may be dedicated to the arts; Saturday may be dedicated to financial matters; and Sunday may be dedicated to real estate. When clicking on a capsulated short information capsule, the visitor is linked to the original article related to the subject matter.

FIG. 9 illustrates said site page that may be divided into at least two columns where the first column in (5000) may be for local news, the column in (5100) for national news, the column in (5200) for international news, and the column in (5300) for non-secular news or thought of the day. When clicking (voice activating or touching) on an item, such as in (5000) a link is formed to the actual article. Likewise, activating the button in (5010) allows the reader to express whether the material is useful and voting for it in (370). Similar functionalities exist throughout the page, where usefulness can be shown in (5110), in (5210), or in (5310) with voting in (370).

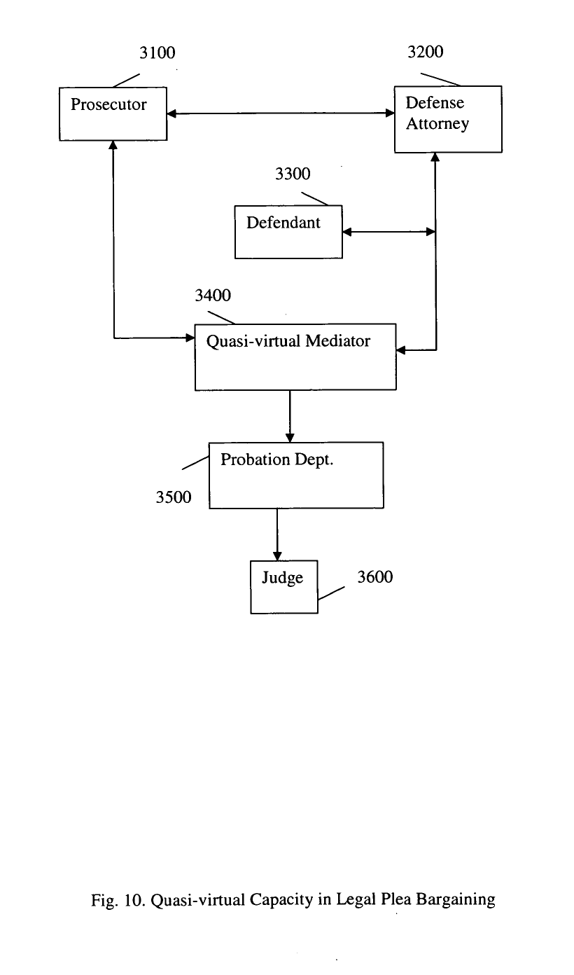

FIG. 10 illustrates quasi-virtual capacity in legal matter (of plea bargaining). The defense attorney in (3200) communicates with the client (defendant) in 3300 and the quasi-virtual mediator in (3400) communicates both with the attorney in (3200) as well as the defendant in (3300) and the prosecutor in (3100). If the mediation does not bring resolution that is fully legal and moral as has been described hereinabove, the quasi-virtual mediator in (3400) may undertake communication with another officer of the court, such as a probation officer in (3500) that may be a proper conduit to the judge in (3600) before the defendant in (3300) appears in court.

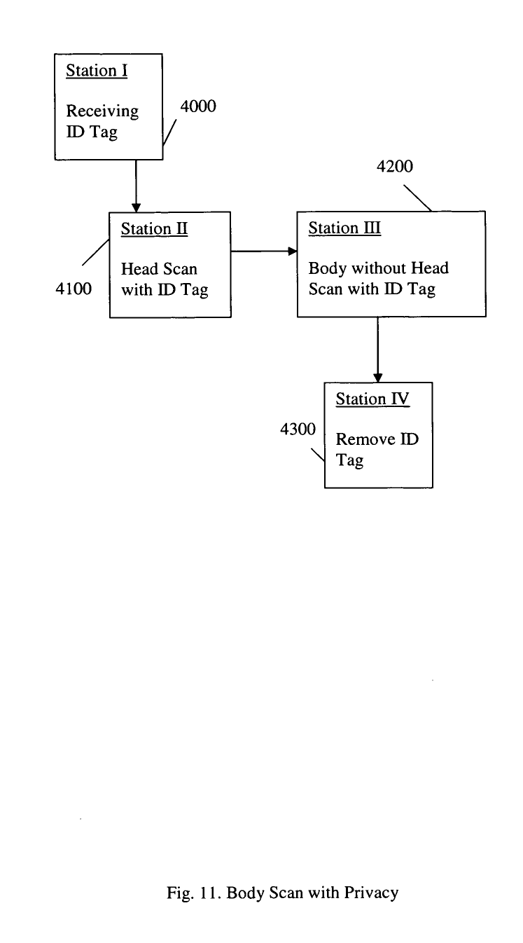

FIG. 11 illustrates solutions embodying security, transparency and individual anonymity. An individual in (4000) receives an identification (ID) tag that may be affixed to at least one of said individual's passport, said individual other identifying instrument, and said individual's body part. Said ID tag may be at least one of a physical ID tag, an imprint ID tag, and an electronic ID tag. Said individual together with said ID tag is then subject to a body scan in station I in (4100), where said body scan is either at least one of a head only or body only scan. Subsequently said individual together with said ID tag is subject to at least one other body scan(s) in at least one other station(s) II in (4200) without scanning of same body part already scanned earlier in (4100). Each body scan is for only one body part and no scanning includes a body part already scanned earlier. Said ID tag that completely identifies said individual may be presented separately from said scans in said stations but related to it in order to unambiguously correlate between the individual and the personal ID tag. After completing at least two of said scans for at least two different body scans, the individual is presented at station III in (4300) where the personal ID tag is at least one of removed, returned, cancelled, erased, obscured and any other form known in the art to render it at least one of a unusable and unrecognizable for future use.

### APPENDIX A

### Site Navigation:

Home
Messages
[Most] Relevant news of the day [A40]
In your face [A10]
Ask your president [A20]
Political Daily Tapestry
   Local & State
   National
   International
   Religion & Spiritual
True or False [A30]
Polls
Polls Summary Page [60]
Continuous Monitoring
The Alternative
Suggestion Box
Virtual Government (SG)
Reports for SG Activities
Daily Issues
Long Term Issues
Forums
Voting
Contributing Rules
What Readers Say
Q&A
   Daily
   Weekly
   Protests & counters
Registration to Site
Registration to vote
Lobbyist
Legislation watchdog
Civil matters
Donation for a Cause [A50]

As can be seen from the foregoing description, a doctrine utility with methods and systems to empower local and world public participation in casting their future that embodies real-time interactions by the public and posting results has been provided and presented. Said provision includes full transparency, a way to affect governing official in a true democratic form, with the alternative potential of a virtual government and/or virtual and quasi-virtual officials, as well as movement between visitors to the site and social networks, with minimal characters posting. While the present invention has been described in the context of specific embodiments thereof, other alternatives, modifications, and variations may become apparent to those skilled in the art having read the foregoing description. Accordingly, it is intended to embrace those alternatives, modifications, and variations.

What is claimed:

1. The method for voting for an individual for at least one of a virtual and quasi-virtual office of political capacity in a regional territory commensurate with said regional territory of the at least one candidate(s) for said office and voting individual; said voting comprising electronic voting, including electronic transmission form; said voting further comprises tallying up said votes.

2. The method in accordance with claim 1, wherein said electronic voting comprising at least one of a text, voice, sign language, touch language and tactile form.

3. The method in accordance with claim 1, wherein said office of political capacity comprising an office of at least one of a local, state, federal, at least one other governing facility(s), and a non-secular office.

4. The method in accordance with claim 1, wherein said quasi-virtual office is an office of at least one of a lobbyist, a legislation watchdog, an arbitrator, a plea-bargain mediator and at least one other office(s).

5. The method in accordance with claim 1, wherein said electronic voting further comprise voting for at least one of a agreement and disagreement to electronic posted material related to a political data comprising at least one of a issue and action.

6. The method according to claim 5, wherein said electronic posted material comprise at least one of a at least one question(s), at least one answer(s), at least one comment(s), and at least one opinion(s).

7. The method in accordance with claim 1, wherein said virtual office of political capacity comprising a real legally governing office;

8. A method for communicating political data of at least one individual(s) comprising at least one device(s) for at least one of a sending, receiving, and posting said data; said data comprising at least one of a at least one question(s), at least one answer(s), at least one comment(s), and at least one opinion(s).

9. A system comprising means for communicating political data of at least one individual(s) comprising means for at least one device(s) for at least one of a means for sending, receiving, and posting said political data; said data comprising at least one of a means for asking at least one question(s), means for providing at least one answer(s), means for expressing at least one comment(s), and means for expressing at least one opinion(s).

10. A system comprising means for voting for an individual for at least one of a virtual and quasi-virtual office of political capacity in a regional territory having the means for being commensurate with the regional territory of the candidate for said office and voting individual; said means for voting comprising means for electronic voting, including means for electronic transmission by mobile communication; said transmission further comprise means for sending and receiving data from the Internet; said means for voting further comprise means for tallying said votes.

11. The system in accordance with claim 10, wherein said means for electronic voting comprising means for at least one of a means for sending and means for receiving at least one of a at least one ASCII character(s), means for using at least one voice transceiver(s), means for using video, and means for using at least one tactile transducer(s).

12. The system in accordance with claim 10, wherein said voting for an office of political capacity comprising means for voting for an office of at least one of a local, state, federal, at least one other governing facility(s), and a non-secular office.

13. The system in accordance with claim 10, wherein said voting for a quasi-virtual office comprises means for voting for at least one of a lobbyist, a legislation watchdog, an arbitrator, a plea-bargain mediator, and at least one other office(s).

14. The system in accordance with claim 10, wherein said means for voting for an individual for a virtual office of political capacity comprising means for said voting for an individual for a real legally governing office.

15. The system in accordance with claim 10, wherein said means for electing an individual to at least one of a virtual and quasi-virtual office of political capacity comprising means for said election to be in at least one of a real life function and a function in a game.

16. The system in accordance with claim 9 having the means for communicating political data comprising means for at least one of a sending and receiving said data wherein said means comprise means for sending and means for receiving at least one of a at least one ASCII character(s), means for using at least one voice transceiver(s), means for using video, and means for using at least one tactile transducer(s).

17. The system in accordance with claim 9, wherein said at least one question(s) comprising means for said question to be directed at a elected official of public office capacity (RLGO); said means for directing said question at said elected official for public office comprising means for selecting said at least one question(s) by having the means for a process comprising means for counting votes for said question from plurality of questions presented by individuals; said official of public office capacity comprising at least one of a mayor, governor, congressperson, senator, president, and at least one other office(s), and a non-secular office.

18. The system in accordance with claim 10, wherein said electronic voting further comprises means for voting for at least one of a agreement and disagreement to electronic posted material related to a political data comprising at least one of a issue and action.
